(19) United States
(12) Patent Application Publication
(10) Pub. No.: US 2004/0133329 A1
(43) Pub. Date: Jul. 8, 2004

(54) Automatic braking device for automobile

(76) Inventor: Gil-Soo Lee, Busan-City (KR)

Correspondence Address: LADAS & PARRY, 224 SOUTH MICHIGAN AVENUE, SUITE 1200, CHICAGO, IL, 60604, US

(21) Appl. No.: 10/628,201

(22) Filed: Jul. 28, 2003

(30) Foreign Application Priority Data
Jan. 8, 2003 (KR) 10-2003-0001116

(51) Int. Cl. G06G 7/00

(52) U.S. Cl. 701/70; 342/71

(57) ABSTRACT

In accordance to automatic automobile braking device in accordance to the present invention, the effect shall be speedy and easy velocity control even when the driver does not take off feet from the accelerator pedal. Moreover, at the time of sudden braking, activation of the brake starts even when the feet reach the brake pedal. Thus, it is possible to decrease braking distance.

### BACKGROUND OF THE INVENTION

1. Field of the Invention

The present invention relates to automatic automobile braking device. In more detail, the present invention relates to the automatic automobile braking device that facilitates velocity control by attaching brake after identifying location of driver's feet by attaching sensor onto the one side of the accelerator pedal.

2. Description of the Prior Art

If and when automobile meets curve while navigating or if and when the distance with the automobile in the front narrows down, driver reduces pressure of the feet that is exerted on the accelerator pedal. At this moment, if and when steep curve or if and when the distance is very narrow, the above mentioned driver further reduces velocity by stepping on the brake after taking off the feet from the accelerator pedal. If and when velocity is again to be increased, then the driver must increase speed by stepping on the accelerator pedal after taking off feet from the brake pedal. Likewise, hitherto automobile in navigation requires change in velocity depending on traffic condition, which entails operating accelerator and brake. Accordingly, problem lies in reduced reaction, caused by susceptibility to fatigue during the process of driving due to the need to switch over to different pedals.

Moreover, if and when there is a need to brake suddenly due to unexpected occurrence at the front, the above mentioned driver needs to operate brake by stepping on the brake pedal after taking off the feet from the accelerator pedal. Hence, the above mentioned results in increased braking distance.

### SUMMARY OF THE INVENTION

The present invention pertains to automatic automobile braking device that is relatively easy to control velocity, and shall pertains to the braking device of automobile that facilitates velocity control and which shall be characterized by; perception part that perceives location of driver's feet and accelerator pedal, control part that outputs braking signal after being input with location of the feet which was identified by the above mentioned perception part, and braking part that reduces velocity by activating the brake while braking signal of the above mentioned control part is being output.

Accordingly, prompt and easy velocity control is enabled even when feet are still on the accelerator pedal.

### BRIEF DESCRIPTION OF THE DRAWINGS

FIG. 1 shall be the perception part of the automatic automobile braking device in accordance to the present invention.

FIG. 2 shall be the figure that depicts the braking part of the automatic automobile braking device in accordance to the present invention.

### DETAILED DESCRIPTION

The present invention was invented to solve the above mentioned problems and the purpose shall be to provide automatic automobile braking device that facilitates velocity control. Another purpose shall be to provide automatic automobile braking device that reduces braking distance at the time of sudden braking.

Composition of the Invention

Towards the above mentioned purposes, the present invention shall be characterized by; perception part that perceives location of driver's feet and accelerator pedal, control part that outputs braking signal after being input with location of the feet which was identified by the above mentioned perception part, and braking part that reduces velocity by activating the brake while braking signal of the above mentioned control part is being output.

Ideally, the above mentioned control part shall be characterized also by the stoppage of deceleration by stopping braking signal if and when the above mentioned driver shall exert pressure on the accelerator pedal.

Moreover, the above mentioned control part receives transmission pertaining to the accelerator pedal and state of accelerator rod's contact from the sensor, installed at the other side of the accelerator. If and when the above mentioned pedal and rod undergo separation, braking signal is transmitted to the above mentioned braking part, and the distance between sensor, installed at the front and back of the automobile, and object, situated at the front and back of the automobile, shall be calculated to transmit braking signal to the above mentioned braking part. Hence, the above mentioned shall be another characteristic.

Braking device for automobile that facilitates velocity control in accordance to the present invention shall be explained by using attached figures as reference.

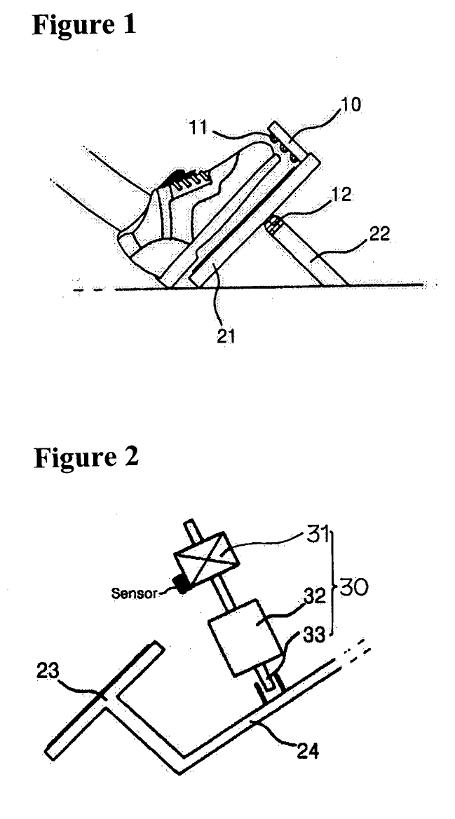

FIG. 1 shall be the perception part of the automatic automobile braking device in accordance to the present invention. FIG. 2 shall be the figure that depicts the braking part of the automatic automobile braking device in accordance to the present invention.

According to the depicted figure, velocity control device in accordance to the present invention can be divided largely into the perception part (10), control part (not figured) and braking part (30).

Perception part (10) shall be explained first. The above mentioned perception part (10) shall be installed at the other side of the accelerator pertaining to the accelerator pedal (21) of automobile's driver seat to identify the location of the accelerator pedal (21) and the feet that are placed on top of the above mentioned pedal. The above mentioned perception part (10) shall be configured to arrange numerous sensors (11) into defined distance. Infrared rays sensor or ultrasonic waves sensor shall be used as the above mentioned sensor. When driver removes feet from the accelerator pedal (21) to reduce velocity, accelerator pedal (21) returns to the upper side. Here, if and when the above mentioned driver continues to remove feet, then the above mentioned accelerator pedal (21) stops without moving beyond fixed degree. Later, end part of the feet shall separate from the above mentioned pedal. When the above mentioned end part of the feet and pedal are separated, the above mentioned perception part identifies height of end part of the feet and shall be transmitted to the control part that shall be mentioned below. At this moment, as mentioned above, it is possible to transmit height of the above mentioned by dividing into stages instead of transmitting the height. In other words, the case in which end part of the feet is attached to the pedal shall be set as stage 0. If and when the height of end part of the feet increases, shall be set at stage 1 and 2, respectively, according to the height of end part of the feet.

Next, explanation pertaining to the control part shall be provided. The above mentioned control part shall be transmitted with the stage that marks the distance of the pedal (21) and feet from the above mentioned perception part (10). According to the stage that the above mentioned perception part (10) is transmitted, control part transmits the braking signal to the braking part (30) that shall be mentioned below.

The transmission of the braking signal into the braking part to enable braking with merely pressure of the feet, situated at the brake pedal after stopping the operation of the brake by perceiving the feet, situated on the brake pedal when it pertains to the above mentioned control part.

At this moment, in case of stage 0 that touches with the feet at the accelerator pedal, transmission of braking signal shall be stopped. At the stage 1 where the end part of the feet is lifted up slightly, lower degree of braking shall be transmitted so that braking shall be realized weakly. As the stage increases as the end part of the feet is lifted up increasingly, braking signal shall be transmitted as the braking intensity increases (for instance, stage 2 shall be 20 as the pressure of stage 1 shall be set at 10). In the case of automobile (mostly large sized automobile), configured separately into automobile, when the above mentioned braking signal starts, if and when the automobile is above the fixed velocity (for instance, 40 km/hr), the above mentioned control part can safely reduce velocity by operating engine brake device of the above mentioned automobile.

Moreover, the above mentioned control part identifies whether the above mentioned accelerator pedal (21) and the above mentioned accelerator's rod (22) are in contact through the sensor (12) that is located at the accelerator's rod or the back part of the above mentioned accelerator pedal that is situated at the accelerator's rod. In the case that the above mentioned pedal and rod are separated, sudden braking signal in transmitted continuously. Since driver's foot moves suddenly towards the brake from the accelerator, the above mentioned accelerator is reinstated, and the above mentioned pedal (21) and rod (22) are separated according to the inertia. At this moment, when pedal and rod are separated, it is a case in which sudden braking is needed. Thus, braking shall take place before stopping on the brake pedal (23). Accordingly, compared braking by moving feet to the brake pedal from the accelerator pedal, brake operates when removing feet from the accelerator, which begins to reduce velocity. Thus, braking distance can be reduced at the time of sudden braking in case of unexpected occurrence.

Moreover, the above mentioned control part identifies the distance between the sensor, installed at the front part of the automobile, (not figured) and the object, situated at the front part of the automobile. If and when the above mentioned distance is below the safe distance level in accordance to the automobile's velocity, then the braking signal shall be transmitted to the above mentioned braking part to prevent collision. If and when below the safe distance level, braking signal shall be stopped. Sensor that perceives objects located at the front of automobile is a technology that is not applicable to the scope of this invention. Thus, detailed explanation shall be omitted.

The above mentioned control part that began to transmit the braking signal shall be transmitted with the signal from the stage 0 that fits driver's feet onto the accelerator from the perception part or shall stop the above mentioned braking signal when the driver steps on the brake.

Next is the explanation pertaining to the braking part (30). The above mentioned braking part shall be comprised of oil pressure pump and oil pressure cylinder. The above mentioned braking part (30) operates the above mentioned brake along the above mentioned control part's signal based on the insertion of the other side of accelerator of the above mentioned oil pressure cylinder's piston into the groove, formed at the other side of accelerator of the road (24) of the brake. When the signal is transmitted in from the above mentioned control part, oil pressure pump (31) shall be activated, and pressure shall be exerted onto the oil pressure cylinder (32), which activates the above mentioned brake pedal. The above mentioned braking part enables gradual braking by exerting power on the above mentioned brake based on the adjustment of pressure within the above mentioned oil pressure cylinder according to the degree of braking that is transmitted by the above mentioned control part. Moreover, if and when the braking signal is not transmitted from the above mentioned control part, original state is reinstated by decreasing the pressure within the above mentioned oil pressure cylinder.

The above mentioned brake's rod and oil pressure cylinder's piston shall be installed separately so that the driver will not face resistance, caused by the pressure within the oil pressure cylinder when the driver steps on the brake pedal.

If and when sudden braking signal shall be transmitted according to the outbreak of unexpected occurrence from the above mentioned control part, the above mentioned braking part shall decrease velocity of automobile by increasing pressure within the above mentioned oil pressure cylinder. At this moment, it is possible to use elasticity of spring (not figured) that is compressed instead of using oil pressure for the sudden braking to transport the piston (33) of the above mentioned cylinder fast. However, if and when automobile is stopped only by using the sudden braking signal, output by the above mentioned control part, the collision with the automobile in the back may result. Therefore, braking shall ultimately take place by the driver's stepping on the brake pedal, and a degree of pressure that can decelerate automobile at the time of sudden braking signal shall be produced.

The following is the example of activating the present invention.

To maintain velocity during navigation, driver exerts continuous pressure on the accelerator pedal (21). To this, the above mentioned perception part (10) notifies with control part that the location of driver's feet is at stage 0.

When the velocity of automobile in the front decreases suddenly, then the above mentioned driver decreases pressure exerted on the accelerator pedal (21) in order to maintain the distance between automobiles. As figured on FIG. 1, driver's feet are separated from the accelerator pedal (21), and the above mentioned perception part perceives that the stage has changed into 1 and transmits this finding to the control part. The above mentioned control part transmits braking signal to the braking part (30), and the above mentioned control part shall activate brake to the pressure of 10 to enable gradual deceleration of velocity.

If and when the above mentioned driver increases the end part of the feet further, the fact that the above mentioned perception part (10) has changed into stage 2 shall be transmitted to the control part. Accordingly, the above mentioned braking part activates brake by exerting pressure of 20 onto the oil pressure cylinder (32). Later at stage 2, if and when the above mentioned driver takes off the feet to change into stage 1, the adjustment takes place at the above mentioned oil pressure cylinder so that the pressure of 10 shall be set.

Accordingly, driver can adjust the degree of braking by adjusting the height of end part of the feet.

If and when the existing driver steps onto the accelerator pedal to increase velocity again, then the above mentioned perception part transmits the fact that the stage has changed into stage 0 to the control part, and the above mentioned control part stops braking signal that shall be transmitted to the above mentioned braking part in accordance to the above mentioned signal. Accordingly, operation of the brake is stopped.

Moreover, sensor, installed at the front part of the automobile, shall transmit the distance with the automobile in the front to the above mentioned control part during navigation. If the distance between automobiles is narrow compared to the velocity of the automobile, then the above mentioned control part shall judge the situation as a collision, and decreases velocity by sending signal to the braking part.

Moreover, if and when the driver finds object at the front part and takes off feet from the accelerator pedal (21) for sudden braking, then the sensor, installed at the back part of the above mentioned accelerator pedal, shall detect this movement and sends signal to the control part. Accordingly, the above mentioned control part sends out signal to the above mentioned braking part for sudden braking. Accordingly, the above mentioned braking part shall use elasticity of spring, attached onto the oil pressure cylinder's piston (33) to activate the above mentioned brake fast, and decreases velocity to enable continuous braking based on the above mentioned oil pressure. Later, automobile is completely stopped with the brake pedaling of the driver.

What is claimed is:

1. Control device for automobile that facilitates speed control and that which is comprised of the following; perception part that detects the location of accelerator pedal and driver's feet, control part that transmits control signal after being input with the location of feet as perceived by the above mentioned perception part, and braking part that decelerates by activating brake while braking signal of the above mentioned control part is being output.

2. When it relates to claim 1, braking device for automobile that facilitates speed control and that which is characterized by the ability to stop deceleration by stopping braking signal when the above mentioned driver exerts pressure on the accelerator pedal.

3. When it relates to claim 1, the above mentioned control part relates to, Braking device for automobile that facilitates velocity control that is characterized by the transmission of the braking signal to the above mentioned braking part at the time when the above mentioned pedal and road are separated when the accelerator pedal and state of accelerator rod's contact are transmitted from the sensor that is installed at the other side of the accelerator.

4. When it relates to claim 1, the above mentioned control part relates to, Braking device for automobile that facilitates velocity control that shall be characterized by the transmission of the braking signal into the above mentioned braking part by calculating the distance with the object, situated at the front and back of the automobile from the sensor that is installed at the front and back of the automobile.

5. When it relates to claim 1, the above mentioned control part relates to, Braking device for automobile that facilitates velocity control by the simultaneous operation of the engine brake during the braking signal transmission.

6. When it relates to claim 1,
automatic braking device for automobile that facilitates velocity control and that is characterized by the transmission of the braking signal into the braking part to brake by merely exerting pressure on the feet. The feet are situated on the brake pedal after stopping the brake by perceiving the feet, situated on the brake pedal.
